(19) United States
(12) Patent Application Publication
(10) Pub. No.: US 2006/0221167 A1
(43) Pub. Date: Oct. 5, 2006

(54) Power conditioning system co-located with a print head for reducing noise, power dissipation, and/or overheating

(75) Inventors: Raymond E. Maynard, Westerly, RI (US); Jeffrey R. Berry, Wakefield, RI (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: ZIH Corp, Hamilton (BM)

(21) Appl. No.: 11/357,394

(22) Filed: Feb. 17, 2006

Related U.S. Application Data
(60) Provisional application No. 60/654,109, filed on Feb. 18, 2005.

(51) Int. Cl. B41J 29/13

(52) U.S. Cl. 347/108

(57) ABSTRACT

The present invention provides an assembly that includes a print head and a power conditioning circuit in a common frame. The co-location of the print head and power conditioning circuit in the frame alleviates added signal noise and power dissipation. Further, it allows for efficient temperature regulation of the two print head and power conditioning circuit.

### CROSS-REFERENCE TO RELATED APPLICATIONS

The present application claims priority from U.S. Provisional Patent Application No. 60/654,109, filed Feb. 18, 2005 and entitled POWER CONDITIONING SYSTEM CO-LOCATED WITH A PRINT HEAD FOR REDUCING NOISE, POWER DISSIPATION, AND/OR OVERHEATING; the contents of which are incorporated by reference herein.

### BACKGROUND OF THE INVENTION

1. Field of the Invention

The present invention relates generally to systems for providing electrical power to a print head of a printer, and more particularly, to regulation of the electrical power with reduced noise, power dissipation, and/or overheating.

2. Description of Related Art

An important aspect in many conventional printers is control of power to the print head. Specifically, most printers incorporate a print head that includes a series of heating elements. The heating elements are individually controlled to either selectively apply ink to a media or to energize inks in the media to create printed indicia. Control of the print elements is crucial to controlling the quality of the printed image. For this reason, it is desirable to provide a clean source of power to the print head that is subject to minimal electrical noise.

In a typical printer, a power conditioning circuit is used to regulate power to the print head. In this regard, a primary power source may provide a first voltage, such as 24 Volts, to the printer. This voltage is provided to the power conditioning circuit, where the voltage is regulated to a second voltage, such as 22 Volts. The power source is typically configured to power various other devices in the printer, such as logic boards, stepper motors, cutters, cooling fans, etc. In some printers, the output of the power conditioning circuit is used to power all of these various devices with a regulated power.

An important drawback for many conventional printers is the location of the power conditioning circuit in the printer. Many printers locate the power conditioning circuit remotely from the print head, either due to space concerns or because the power conditioning circuit is used to power more items than just the print head. This remote location of the power conditioning circuit may cause various problems. First, due to its remote location, a relatively lengthy power bus or series of wires must be routed between the power conditioning circuit and the print head. This can lead to power loss due to energy dissipation along the power bus or wires. Further, the power signal is susceptible to electrical noise, which may be introduced along the length of the power bus or cabling. Second, for some printers, the print head is located in a cover or top portion of the printer, and the power conditioning circuit may be located in a bottom portion of the printer. This configuration allows for easy loading of media and ribbon by opening and pivoting the cover such as to locate the ribbon and/or media between the print head and platen. The constant opening and closing of the cover can damage the power bus or cabling.

Another problem with this configuration is the difficulty in providing efficient component cooling or heating. For example, both the print head and the power conditioning circuit could generate significant heat. Overheating of these components can affect print quality and/or possibly cause errors or malfunctions in the printer. In some applications, the printer is subjected to a low temperature environment, which could also affect performance. In printers where the power conditioning circuit and print head are located remote from one another, the printer may include separate respective temperature regulators, which can increase the cost and size factor of the printer. Further, in this regard, in many applications, it is important to reduce the amount of dust and foreign materials from entering the printer. The use of cooling fans can exasperate this problem.

### BRIEF SUMMARY OF THE INVENTION

The present invention overcomes the above and other disadvantages with prior printer configurations. The present invention provides various systems, printers, and methods for providing power conditioning for a print head in an efficient manner. For example, in one embodiment, the present invention provides a power conditioning assembly. The assembly includes a housing or frame for maintaining a print head. Further, the housing or frame also includes a power conditioning circuit that allows for electrical coupling between the power conditioning circuit and the print head. The assembly is configure such that the power conditioning circuit and print head are co-located, (i.e., adjacent to each other), in the printer. Specifically, the connector of the power conditioning circuit is typically in a range of 0 to 5 inches, and more usually in a range of 0 to 1 inches from the connector of the print head. This arrangement allows for use of power bus or cabling having a short length. This, in turn, reduces the introduction of electrical noise and reduces losses due to dissipation in the power bus or cabling.

The assembly also provides an efficient system for regulating the temperature of the power conditioning circuit and print head. For example, where component overheating is an issue, the housing or frame may be formed from metal, which allows for heat dissipation. Further, the housing or frame may include space to accommodate one or more heat sinks. Further, because the power conditioning circuit and print head are co-located in the same assembly, a common cooling fan may be used to regulate heat in both the power conditioning circuit and the print head. In cold temperature environments, the frame may be made of insulative material, and a heating element may be located to heat the power conditioning circuit and print head.

Additionally, the assembly may be configured such that it defines an enclosure having an opening for accommodating communication with a cooling fan. In some embodiments, the enclosure is situated near the outer cover of the printer and in communication with a cooling fan. The enclosure receives air from the fan for cooling the print head and conditioning circuit. Importantly, because the remaining portions of the assembly are closed, the cooling air is not introduced into the remaining portions of the printer, thereby allowing the print head and related circuitry to be cooled without introducing air into the remaining portions of the printer.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view of a power conditioning assembly according to one embodiment of the present invention;

FIG. 2 is a perspective view of a printer in an open configuration containing the power conditioning assembly of FIG. 1 in a cover of the printer;

FIG. 3 is a cross-section view of the printer of FIG. 2 in a closed configuration containing the power conditioning assembly of FIG. 1; and

FIG. 4 is a perspective view of the printer of FIG. 2 in a closed configuration.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

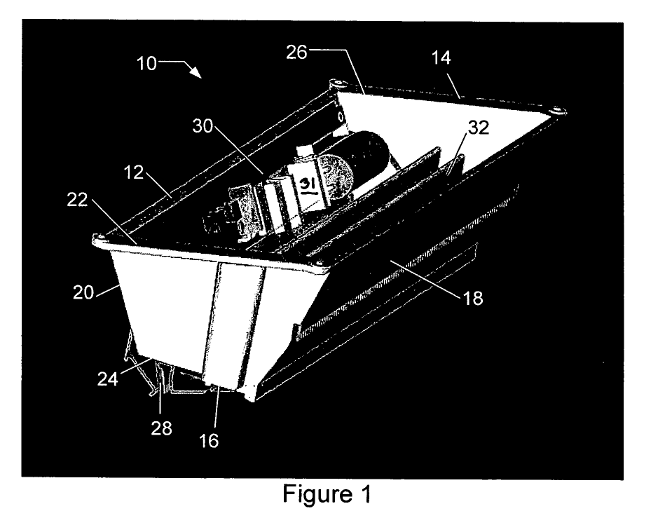

FIG. 1 is an illustration of a power conditioning assembly 10 according to one embodiment of the present invention. The assembly comprises a frame 12 having a width extending between opposed surfaces, 14 and 16, a height extending between opposed surfaces 18 and 20, and a depth extending between opposed surfaces, 22 and 24. A cavity 26 is defined in the frame 12. Located on the frame and typically in the cavity is a print head 28. The print head has a surface containing the print elements extending from the bottom of the cavity for contacting media as it is passed under the print head.

Also located in the frame 12 is a power conditioning circuit 30 configured to provide properly conditioned power to the print head. The power conditioning circuit may be located adjacent to the print head in the frame. For example, in the illustrative embodiment, the print head 28 is located on one surface, e.g., 24, of the frame, while the power conditioning circuit is located on a second surface, e.g., 20, of the frame. The power conditioning circuit 30 and the print head 28 are electrically coupled to one another by either a power bus, power cabling, or other electrical means, not shown.

The length of the coupling between the power condition circuit and the print head is generally held to a minimum, such as 0 to 5 inches, and more typically, 0 to 1 inch. This spacing may significantly reduce the introduction of electrical noise to the print head. The noise can be maintained to a minimum dB level. Added noise reduction features such as shielding may also be employed in the frame to further reduce noise.

It is understood that the power conditioning circuit and print head may assume any desired form in any shaped assembly. One of the important aspects is that the power conditioning circuit is in close proximity to the print head. In the illustrative embodiment, the power conditioning circuit and print head are illustrated as separate components. In some embodiments, the power conditioning circuit and print head can be resident in the same component, if so desired.

The power conditioning circuit may be of any configuration to coincide with the parameters of the print head. As an example, in one embodiment, the power conditioning assembly is employed in a thermal photo printer. In this embodiment, the power conditioning circuit receives an unconditioned voltage of approximately 24 Volts and provides a conditioned 22 Volts to the print head. In this particular embodiment, the power conditioning circuit can be designed to provide power only to the print head, while the logic boards, stepper motors, etc. received less-critically regulated power from the 24 Volt source. The 2 Volt difference between the 24 Volt power source and the 22 Volt power required for print head operation provide head room to allow the power conditioning circuit to condition the power.

In addition to reducing electrical noise and power loss, the power conditioning assembly of some embodiments may also provide various features for efficient heat regulation. For example, as illustrated in FIG. 1, the power conditioning assembly 10 may include a frame 12 formed of metal or a similar material capable of dissipating heat. Further, the frame may include a heat sink 32 for dissipation of heat. Alternatively, the frame could include a heater or other device for use in applications where the printer is subjected to a cold environment. Further, the frame could be formed from an insulative material. Any system for temperature regulation could be considered for implementation in the assembly. In one embodiment, the heat sink 32 is configured to dissipate heat in the print head 28 and a separate heat sink 31 is configured to dissipate heat in the power conditioning circuit 30.

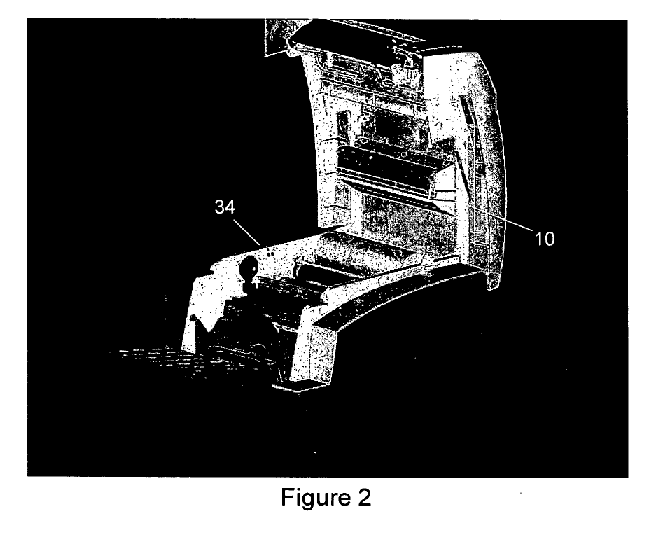

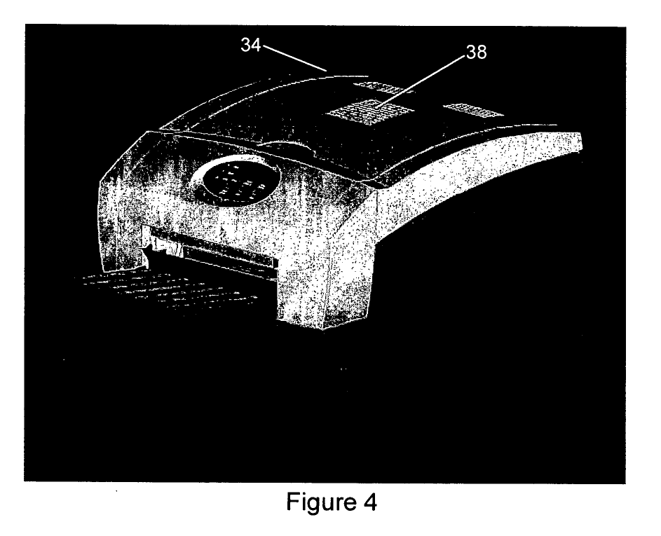

The co-location of the power conditioning circuit and the print head in the same assembly further allows for efficient temperature control of the power conditioning circuit and print head. For example, FIGS. 2-4 illustrate an embodiment of the power conditioning assembly 10 located in a printer 34. As illustrated, the assembly may be located at a position in the printer to allow the print head to mate with a platen for printing. Because the power conditioning circuit and print head are located in the assembly, one temperature regulation system can be used to regulate the temperature of both devices. For example, in the illustrative embodiment, a single fan 36 may be located adjacent to the assembly. As illustrated in FIG. 4, the fan can work in conjunction with vents 38 in the housing of the printer. The fan can be operated so as to regulate the temperature of the power conditioning circuit and print head. Similarly, a heater or similar device could also be employed. In some embodiments, the temperature regulator may be located in the assembly itself.

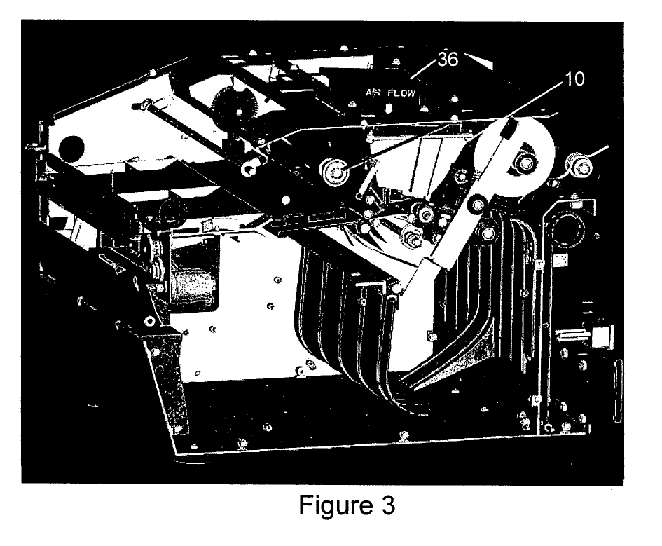

As illustrated in FIGS. 3-4, in some embodiments, the assembly defines an enclosure having four sides and at least a bottom side. The top side includes an opening for communicating with a heating or cooling unit. As the assembly is an enclosure, air introduced into the enclosure does not escape other than from the opening in the top. Similarly, if a vacuum is applied to the enclosure, air is not introduced from the outside environment other than the opening in the top surface of the enclosure. This configuration of the assembly is used to reduce the amount of air and dust that would otherwise be introduced in the printer by the heating or cooling device.

For example, as illustrated in FIGS. 3-4, the assembly is adjacent an outer surface of the printer or similar device. The assembly creates a generally air tight seal with the outer enclosure of the printer. Located above the assembly and in communication with an opening of the top surface of the assembly is a heating or cooling unit for either forcing air into the cavity of the enclosure of the assembly or for creating a vacuum in the opening. In this configuration, due to the assembly being enclosed and forming a seal with the printer body, air introduced into the opening in the top surface of the enclosure is not introduced into the remainder of the printer. Similarly, if a vacuum is applied, other openings in the printer do not allow for air flow from the printer body to the assembly. As such, dust and other particles are prevented from entering the printer.

The above embodiments illustrate the assembly of the present invention in use with a print head. It is understood that the concepts embodied herein are not limited to providing power to a print head. The assembly is envisioned for use in any application where it is desirable to provide conditioned power to a component with reduced noise or signal loss or where it is desirable to provide temperature regulation for two or more components.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A print head assembly comprising:
a frame defining a cavity having sides and at least one of a top or bottom surface;
an opening in a surface of said frame;
at least a print head located in the cavity of said frame; and
a temperature regulator in communication with said opening for regulating the temperature in said cavity.

2. An assembly according to claim 1, wherein said frame is at least partially located in a printer enclosure, wherein the cavity of said frame is at least partially isolated from the printer enclosure.

3. An assembly according to claim 1, wherein said frame is at least partially located in a printer enclosure, wherein the cavity of said frame is at least partially isolated from the printer enclosure such that air located in the cavity of said frame is not capable of entering the printer enclosure.

4. An assembly according to claim 1 further comprising a power conditioning circuit located in the cavity of said frame and connected to said print head.

5. A printer assembly comprising:
a housing;
a print head assembly located in said housing, said print head assembly comprising:
a frame defining a cavity having sides and at least one of a top or bottom surface;
an opening in a surface of said frame;
at least a print head located in the cavity of said frame;
a temperature regulator in communication with said opening for regulating the temperature in said cavity,
wherein the cavity of said frame is at least partially isolated from the printer enclosure such that air located in the cavity of said frame is not capable of entering the printer enclosure.

6. An assembly for providing conditioned power to a printer, comprising:
a frame;
an electrical component coupled to said frame, said component requiring conditioned power; and
a power conditioning circuit coupled to said frame and to said electrical component for providing conditioned power to said component.

7. An assembly according to claim 6, wherein said electrical component is a print head.

8. An assembly according to claim 6 further comprising an electrical connector associated with each of said power conditioning circuit and said electrical component, wherein said connectors are space apart between 0 to 5 inches.

9. An assembly according to claim 6, wherein said power conditioning circuit and said electrical component are integrated into one component.

10. An assembly according to claim 6 further comprising a temperature regulator.

11. An assembly according to claim 10, wherein said temperature regulator is one of a heat sink, heater, fan, and cooler.

12. An assembly according to claim 6 further comprising an electrical coupling means for electrically coupling said power conditioning circuit and said electrical component, the electrical coupling means having a length, the length being the distance that an electrical signal travels via the electrical coupling means between said power conditioning circuit and said electrical component, wherein the length is between 0 and 5 inches.

13. An assembly according to claim 12, wherein the length is between 0 and 1 inch.

14. An assembly according to claim 6, wherein the assembly is a part of a thermal photo printer.

15. An assembly according to claim 6, wherein the frame comprises a cavity having a top side and a bottom side joined by opposing sidewalls, and wherein the electrical component is located in the bottom side and the power conditioning circuit is located on a sidewall adjacent to the electrical component.

16. A printer comprising:
an assembly comprising:
a frame;
an electrical component coupled to said frame, said component requiring conditioned power; and
a power conditioning circuit coupled to said frame and to said electrical component for providing conditioned power to said component; and
a temperature regulator located relative to said electrical component and power conditioning circuit.

17. A printer according to claim 16, wherein said electrical component is a print head.

18. A printer according to claim 16, wherein said temperature regulator is one of a heat sink, heater, fan, and cooler.

19. A printer according to claim 16 further comprising an electrical coupling means for electrically coupling said power conditioning circuit and said electrical component, the electrical coupling means having a length, the length being the distance that an electrical signal travels via the electrical coupling means between said power conditioning circuit and said electrical component, wherein the length is between 0 and 5 inches.

20. A printer according to claim 19, wherein the length is between 0 and 1 inch.

21. A printer according to claim 16, wherein the printer is a thermal photo printer.

22. A printer according to claim 16, wherein the frame comprises a cavity having a top side and a bottom side joined by opposing sidewalls, and wherein the electrical component is located in the bottom side and the power conditioning circuit is located on a sidewall adjacent to the electrical component.

23. A printer according to claim 22, wherein the temperature regulator is located at the top side of the cavity.

24. An assembly for use in a printer, comprising:
a print head, said print head requiring conditioned power; and
a power conditioning circuit for providing conditioned power to said print head, wherein said power conditioning circuit and said print head are integrated into one component.

25. An assembly according to claim 24 further comprising a means for regulating the temperature of the print head and power conditioning circuit component.

26. An assembly according to claim 25, wherein said means for regulating the temperature is one of a heat sink, heater, fan, and cooler.
